(19) United States
(12) Patent Application Publication
(10) Pub. No.: US 2012/0257530 A1
(43) Pub. Date: Oct. 11, 2012

(54) Communication Method and Devices for High Density Wireless Networks

(75) Inventors: Dennis Bijwaard, Enschede (NL); Paul Havinga, Saasveld (NL); Lodewijk Van Hoesel, Enschede (NL)

(73) Assignee: AMBIENT HOLDING B.V., Enschede (NL)

(21) Appl. No.: 13/505,057

(22) PCT Filed: Nov. 1, 2010
(86) PCT No.: PCT/NL2010/050729

§ 371 Date: Jun. 25, 2012

(30) Foreign Application Priority Data
Oct. 30, 2009 (NL) 2003736

(51) Int. Cl. H04W 72/04; H04W 52/24; H04W 24/02

(52) U.S. Cl. 370/252; 370/330

(57) ABSTRACT

This document describes a method for wireless communication in large-scale monitoring and actuation applications. Typically, these networks must be designed to use efficiently available bandwidth in the wireless communication channel and to be able to deal with high node densities. The method mitigates the effects of co-channel interference, while allowing spatially distributed simultaneous transmissions.

The present invention relates to a communication method for high density wireless networks.

The present invention also relates to a terminal for use in a high density wireless network.

The present invention further relates to a cluster master device for use in a high density wireless network.

The present invention also relates to a central node for use in a high density wireless network.

Furthermore, the present invention relates to a system for use in a high density wireless network.

Large-scale wireless sensor and actuator networks (LWSANs) are networks that consist of many sensor and/or actuator devices (i.e. >1,000 devices). These sensor and/or actuator devices (also called nodes) communicate wirelessly to deliver their sensor readings to one or more gateway devices in the network or to receive information from other parts of the networks to carry out actuation tasks or receive configuration information.

This document describes the organization of wireless communication for large-scale monitoring and actuation applications. Typically, these networks must be designed to use efficiently available bandwidth in the wireless communication channel and to be able to deal with high node densities. Envisioned deployments of such networks consist of several square kilometers of terrestrial surface with nodes every few square meters. This enormous deployment area, the high sensor density and the (potential) large data volume that must be transported (potentially near real-time) make an interesting challenge. This document describes methodology to organize communication in LWSANs. Topics like spatial time slot and frequency allocation and medium access control protocols are discussed.

One of the typical requirements is that the information transfer from sensor to storage point needs to be (near) real-time. The reason for this is manifold: (1) sensor nodes must be cheap and therefore cannot store sensor traces, (2) ease of data collection is guaranteed when data is soon after sampling stored in a (central) database and (3) the system is not feasible when it takes longer to transport the data than to obtain (sample) it; any backlog introduces higher operational costs. The system design is optimized for this type of application. However, it might be applicable to different uses. Its scope is therefore not limited to devices unable to store information traces.

### PRIOR ART

In the last decade, wireless sensor networks have been described extensively in research literature [Estrin et al., 1999, Next century challenges: Scalable coordination in sensor networks, MobiCom'99], [Kahn et al., 1999, Next century challenges: Networking for “Smart Dust”, MobiCom'99], [Römer et al., 2004, The design space of wireless sensor networks, IEEE Wireless Communication Magazine]. The general idea is to equip sensors with (wireless) communicating capabilities, so called sensor nodes. Typically, these sensor nodes use a network stack (i.e. a set of protocols) to communicate with each other e.g. in mesh network formation, to deliver sensor readings to one or more data sinks.

In US patent application U.S. 2009/092112, a method of clustering in wireless sensor network systems is described. Ku et al. introduce the concept of cluster heads i.e. nodes which aggregate information from one or more sensors nodes. The patent describes how to adjust the cluster size and how to merge clusters. Other communication aspects are not discussed. The term cluster is in our invention defined as a geographical region opposed to the definitions used in the prior art.

US Patent application U.S. 2009/191906 describes a frequency channel allocation methodology to reduce co-channel interference. The patent uses dedicated gateways to determine interference levels, which are then communicated (via IP network) with all gateways in the system. Then a phase of spectrum negations takes place. Our methodology relies on self-organization or frequency channel and time slot allocation, before deploying the network. Also, our invention does not require inter-gateway communication.

### SUMMARY OF THE INVENTION

The invention describes a methodology to allow spatial reuse of the wireless medium for large-scale wireless sensor and actuator networks. The methodology uses the concept of clustering to organize communication on micro-scale, while keeping the macro-scale frequency channel and time slot assignments into consideration.

The object of the invention is achieved by providing a communication method for high density wireless networks, comprising the steps of: providing a terminal comprising a radio receiver, the terminal being comprised by one cluster comprising at least one terminal, and wherein the cluster is associated with a geographical area wherein the terminal is located; for each cluster, providing a cluster master device associated with the cluster, the cluster master device comprising a radio transmitter and a radio receiver; and providing a central node associated with at least one cluster, the central node comprising a radio transmitter and a radio receiver; wherein a plurality of clusters are associated with a super cluster; wherein communication slots are delimited in time and frequency; further comprising the steps of: within a super cluster, allocating communication slots to clusters; the cluster master device determining a schedule allocating communication slots allocated to the cluster, to the terminals comprised in the cluster; the cluster master device communicating the schedule to the terminals comprised in the cluster. By creating a geographical hierarchy of super clusters and clusters, and sensors/actuators within the clusters, and allocating frequency and time delimited slots to subsequently super clusters, clusters, and the sensors and actuators in a cluster, the available frequency bandwidth in a geographical area is efficiently reused. Within a super cluster each time and frequency delimited communications slot is allocated only once. Within the super cluster every cluster is allocated a set of time and frequency delimited communications slots, and subsequently, within a cluster, the allocated communication slots are allocated to individual sensors and/or actuators. By means of this method according to the present application the geographical reuse of frequency slots is achieved with a minimal amount of co-channel interference.

The present invention further provides a method, wherein the terminal comprises an actuator for executing a command received from the cluster master device.

Furthermore, a method is provided, wherein the terminal comprises a sensor for measuring a physical quantity, the terminal further comprising a radio transmitter for communicating a representation of the measured quantity to the cluster master device during a communication slot allocated to the terminal.

Especially in wireless sensory networks and wireless control networks, the geographical distribution of network nodes is typically relatively dense, and the risk of co-channel interference increases with the density of the network. Therefore, the methods according to the present invention are well suited for wireless sensory networks and wireless control networks.

According to a further aspect of the present invention, a method is provided, wherein the terminal comprises a radio transmitter, the method further comprising the steps of: the cluster master device determining a quality metric of the signal received from a terminal; the cluster master device including the determined received signal quality metric in a subsequent transmission; and the terminal for which the received signal quality metric was determined, adjusting its transmitting power in order to minimise the transmitting power without the received signal quality metric dropping below a predetermined threshold. Because the cluster master device feeds back to the terminals a quality metric of the received signal, the terminals are capable of minimising their transmitting power without running the risk of the cluster master device no longer receiving the signals transmitted by one or more of the terminals. This results in the geographical area wherein a terminal's transmitted signal can be detected, being minimised and therefore minimised the distance between terminals that use the same frequency and time delimited communication slots. Accordingly, the geographical density of the reuse of communication slots in a particular geographical area is maximised. A further advantage is the reduced power use for the terminals. Wireless terminals are often mobile terminals and are therefore often battery operated. The present invention allows for efficient battery utilisation.

The present invention further provides a method, wherein the terminal comprises a radio transmitter, the method further comprising the steps of: a terminal determining a quality metric of the signal received from a cluster master device; the terminal including the determined quality metric of the received signal in a subsequent transmission; and the cluster master device for which the received signal quality metric was determined, adjusting its transmitting power in order to minimise the transmitting power without the received signal quality metric dropping below a predetermined threshold. By also feeding back the quality of the signal as received by the transmitters, the cluster master device is also able to cut back its transmitting power in order to obtain a further reduction of geographical frequency occupation, allowing for a denser network of nodes.

Furthermore, the present invention provides a method, wherein the quality metric is the signal strength or the signal to noise ratio of the received signal.

In an embodiment the present invention further provides a terminal comprising: a radio receiver, and an actuator; wherein the terminal is associated with a cluster comprising at least a terminal and a cluster master device; and wherein the terminal is configured to: receive a schedule comprising allocations allocating a communication slot, delimited in time and frequency, to the terminal; and receive a command to be executed by the actuator during the communication slot allocated to the terminal.

In an alternative embodiment the present invention provides a terminal comprising: a radio receiver, a radio transmitter, and a sensor; wherein the terminal is associated with a cluster comprising at least a terminal and a cluster master device; and wherein the terminal is configured to: receive a schedule comprising allocations allocating a communication slot, delimited in time and frequency, to the terminal; and transmit measurement data acquired by the sensor during the communication slot allocated to the terminal.

The terminals according to the present invention are configured to receive a schedule, which schedule allocates a communication slot to the terminal. The communication slot is delimited in time and frequency, meaning a frequency (with some bandwidth defined around it) and a time period is associated with it, during which time period the terminal is allowed to use the frequency associated with the communication slot. A terminal according to the present invention allows for a centralised allocation of communication slots in order to reuse communication slots geographically making more dense wireless networks possible due to a more efficient use of the available frequencies.

In a preferred embodiment, the present invention provides a terminal, comprising a radio transmitter, the terminal further comprising: quality metric determination means for determining a quality metric for the signal received from a cluster master device, wherein the quality metric determination means are connected to the transmitter;

and wherein the terminal is configured to send after determination of the quality metric, during a subsequent transmission, the determined received signal quality metric by means of the transmitter. As already described above, such a terminal allows for the cluster master device to minimise its transmission power without the risk of the terminal not being able to reliably receive the signal transmitted by the cluster master device. The determined received signal quality metric may be transmitted by the terminal in a special message dedicated for this purpose, however, in a preferred embodiment the determined received signal quality metric is piggybacking with another message.

In another embodiment according to the present invention, a terminal is provided, comprising a radio transmitter, the terminal further comprising: transmitting power control means connected to the transmitter for controlling the power of the transmitter, the transmitting power control means further being connected to the receiver; wherein the receiver is configured to receive a received signal quality metric; and the transmitting power control means are configured to minimise the transmitting power while keeping the received signal quality metric above a predetermined threshold. As also described above, the transmitting power of the terminals according to this particular embodiment is also minimised. The terminal receives a quality metric describing the quality of the signal transmitted by the terminal and as it is received by the node transmitting the quality metric. By means of the transmitting power control means, the terminal minimises its transmitting power, at the one hand reducing the geographical occupancy of the frequency allocated to it by means of the schedule and allowing for a more dense wireless network, and at the other hand reduces the power consumption, which is especially advantageous when the terminal is a battery powered device.

In an embodiment the present invention also provides a cluster master device comprising: a radio receiver, and a radio transmitter; wherein the cluster master device is comprised by a cluster, further comprising at least a terminal; and wherein the cluster master device is configured to determine a schedule comprising allocations allocating a communication slot, delimited in time and frequency, to each terminal associated with the cluster; and wherein the cluster master device is configured to: transmit to a terminal in its associated cluster, the terminal comprising an actuator, a command to be executed by the actuator, the transmission of the command being scheduled during the communication slot allocated to the terminal according to the transmitted schedule; and/or receive from a terminal in its associated cluster, the terminal comprising a sensor, measurement data acquired by the sensor, the transmission of the measurement data being scheduled during the communication slot allocated to the terminal according to the transmitted schedule. In accordance with the above description relating to the methods according to the present invention, the cluster master device allows for the efficient reuse of frequencies in a geographical area by sending a schedule to terminals in a cluster comprising also the cluster master device, the schedule allocating communication slots to the terminals.

In a further embodiment, the present invention provides a cluster master device, further configured to transmit to a central node measurement data received from a terminal comprising a sensor, to store the measurement data. In a wireless sensory network according to the present invention, data is collected by sensors. The sensors are comprised in terminals, the terminals further comprising a transmitter. By means of the transmitter, the collected data is transmitted to a cluster master device. Eventually, the cluster master device retransmits the collected data to a central node that is configured to store the collected data.

In a further embodiment, a cluster master device is provided, configured to receive from a central node a plurality of allocations of communication slots, the communication slots being delimited in time and frequency, and to determine the schedule comprising the allocations in accordance with the plurality of received allocations. This embodiment is particularly useful in a system, wherein clusters of nodes are arranged in super clusters. Within each super cluster the communication slots in the set of available communication slots, the slots being delimited in time and frequency, are allocated to the clusters in the super cluster. The central node sends the allocation of the communication slots to the cluster master device in the clusters. Each cluster master device further allocates the communication slots allocated to its cluster to the terminals in its cluster and sends this allocation by means of the schedule to the terminals in the cluster. As each communication slot is a unique combination of frequency and time in a super cluster, co-channel interference is minimised among the nodes in the super cluster.

In an alternative embodiment, a cluster master device is provided, configured to: receive a schedule transmitted by a second cluster master device and associated with a second cluster; and determine the schedule comprising the allocations of communication slots for the cluster associated with it by avoiding the usage of allocations of communication slots comprised in the received schedule of the second cluster master device. In this particular embodiment, cluster master devices listen for broadcasts from other cluster master devices and are configured to receive the schedules transmitted by other cluster master devices. If schedules from other cluster master devices are received, the cluster master device generates a schedule for the terminals in its own cluster wherein the communication slots allocated by the other cluster master devices are avoided.

In a further embodiment according to the present invention, a cluster master device is provided, comprising: quality metric determination means for determining a quality metric for the signal received from a terminal, wherein the quality metric determination means are connected to the transmitter; and wherein the cluster master device is configured to send after determination of the quality metric, during a subsequent transmission, the determined received signal quality metric by means of the transmitter.

In another embodiment according to the present invention, a cluster master device is provided, comprising: transmitting power control means connected to the transmitter for controlling the power of the transmitter, the transmitting power control means further being connected to the receiver; wherein the receiver is configured to receive a received signal quality metric; and the transmitting power control means are configured to minimise the transmitting power while keeping the received signal quality metric above a predetermined threshold.

Furthermore, the present invention provides an apparatus, wherein the received signal quality metric is the signal strength or the signal to noise ratio of the received signal.

The present invention also provides an embodiment by means of a central node comprising: a radio receiver, and a data storage; wherein the central node is configured to receive measurement data from a cluster master device, and to store the received measurement data in the data storage. As described above, in a wireless sensory network, data is collected by terminals comprising sensors. The terminals transmit the collected data to the cluster master device of their cluster. Subsequently, the cluster master device forwards the collected data to a central node, which central node is specifically configured to store the sensory data.

The present invention also provides a central node comprising: a radio transmitter for communicating with at least one cluster master device, the cluster master device being comprised in a cluster further comprising at least one terminal, the cluster being comprised in a super cluster comprising at least one further cluster; means for determining for each cluster in the super cluster, an allocation of communication slots, delimited in time and frequency; wherein the central node is configured to transmit the allocation of communication slots to the cluster master device of each cluster in the super cluster. The central node according to this embodiment allocates available communication slots to each cluster in a super cluster, ensuring an allocated communication slot is allocated to a cluster only once in a super cluster. Once communication slots are allocated, the central node transmits the allocations to the cluster master devices of the clusters.

In an embodiment the present invention provides a system comprising a terminal according to the present invention; a cluster master device according to the present invention; and a central node according to the present invention.

### BRIEF DESCRIPTION OF FIGURES

FIG. 1 illustrates the components of the large-scale wireless sensor and actuator network. The system groups sensor/actuator nodes with data collectors based upon their geographic position.

FIG. 2 shows communication patterns in the large-scale wireless sensor and actuator network, and illustrates how co-channel interference exists. This patent describes communication methodologies, which mitigate the illustrated co-channel interference by using cluster and super cluster structures.

FIG. 3 depicts the communication protocol at micro-scale that is used to organize communication between sensor/actuator nodes and their appointed data collectors.

FIG. 4 shows how this micro-scale protocol is applied in at macro-scale to organize the communication in multiple clusters to mitigate the effects of co-channel interference.

FIG. 5 depicts an example embodiment.

### DETAILED DESCRIPTION

Layered Wireless Communication Architecture: Macro and Micro-scales

A layered organization of the LWSAN in terms of communication is proposed. At the first communication layer, sensor information is collected into data collector devices (DCs) using radio frequency (RF) transmissions. The DCs (also referred to as cluster master) organize the wireless communication at micro-scale. At the macro-scale, the communication is organized in network wide sense, such that the wireless medium is spatially reused in both time and frequency domains, such that co-channel interference is mitigated.

To complete the large-scale wireless sensor and actuator network, DCs need to deliver the collected information to one or more central storage points (SPs), also referred to as central nodes. In addition, control and configuration information needs to be propagated from SP to wireless sensors via the DCs. The communication between DCs and SP(s) is outside the scope of this patent.

Micro-scale: Wireless Sensor to Data Collector Communication

At macro-scale, wireless sensors (also referred to as terminals) are grouped into clusters. Clusters can have any arbitrary geographical shapes, such as but not limited to closed polygons. Typical shapes are rectangles or hexagons. All wireless sensors within the geographical boundaries of a cluster belong to that cluster. Wireless sensors belong to at most one cluster. Clusters are identified by a unique number. Within a cluster, wireless sensor nodes are arbitrary positioned. In another embodiment of this patent, sensor nodes are deployed in a grid-like fashion.

Each of these clusters is intended to operate independently in terms of wireless communication and each can be regarded as a separate WSN. Within the cluster, one DC collects all sensor data and takes care of synchronizing the sensor nodes in its cluster. Additionally, it organizes communication in its cluster through a communication protocol. This protocol is defined later on in this patent.

The invention allows wireless devices to share a (small) set of (orthogonal) frequency channels and a (small) set of time slots, in cases where the sum of the generated data volume is larger than the summed data bandwidth of the single frequency channels. In particular, spatial reuse of the wireless communication medium is used, while keeping interference levels at a minimum.

As first option, a data collector device is centrally informed (e.g. via SP) of wireless communication parameters it needs to respect, such as the frequency channel it needs to use and the exact moments it might emit energy in the frequency channel or might request wireless sensors to emit energy in the frequency channel. We denote these communication parameters respectively as frequency channel (denoted with f) and time slot (denoted with t), which describes when the data collector device (periodically) might emit energy in the wireless medium, or when the wireless sensors in the cluster of the data collector might emit energy.

As second option, a data collector device retrieves the communication parameters through self-configuration e.g. by assessing the frequency band usage and time slot usage by other data collectors and/or interpreting explicitly transmitted information by other data collectors and/or random selection of communication parameters in case of selection ties or insufficient information to carry out a selection otherwise.

The Micro-scale Communication Protocol

In our communication protocol at the first layer, the date collector devices respect the macro-scale communication parameters f and t, and ensure that wireless sensors in its cluster also respect the parameters at all times.

The data collector device creates a schedule for the period it and the wireless sensor nodes belonging to its cluster is/are allowed emitting energy in the wireless medium. The schedule describes which devices (by identification number) might transmit information (i.e. wireless sensors and the data collector itself). In another embodiment of this invention, the schedule might include reserved time for random access of the wireless medium, in which any wireless sensor might announce itself and transfer information to the data collector. The data collector propagates the schedule to the wireless sensors in its cluster, including information about the duration of the time interval in which energy might be emitted in the wireless medium and a description of when the data collector will announce a next schedule (while respecting the t and f parameters). Timing information can be expressed as relative or absolute time.

The wireless sensors respect the schedule as given by the data collector device and carry out receives and transmit operations according to the given schedule. The wireless sensor devices synchronize with the data collector and ensure that they receive the next schedule.

When a wireless sensor device is not needed for communication within the communication interval of the cluster (as announced by the data collector) or outside the communication interval, it might switch off its RF communication modality and consequently neither transmits nor receives. This can be beneficial for the energy-consumption of the wireless sensor node.

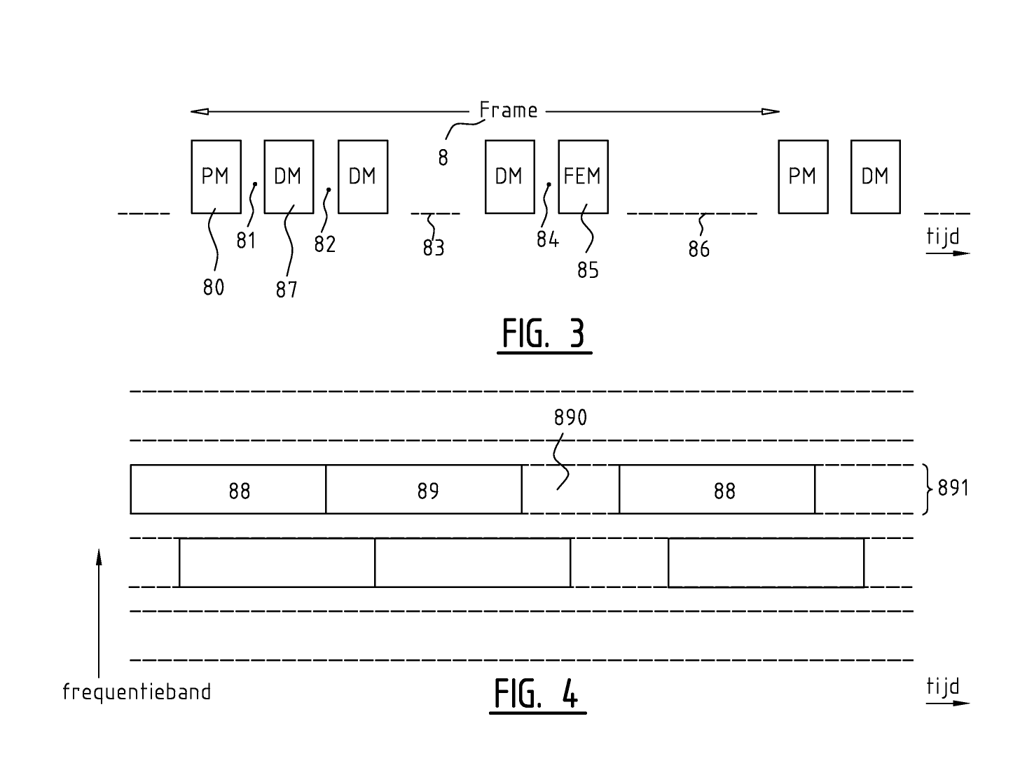

The micro-scale protocol is illustrated in FIG. 3 and is explained later in the patent.

Macro-scale: Independency of Communication Between Clusters

In the previous section, a communication methodology has been described at micro-scale. In this section, we discuss how a large-scale sensor and actuator network can be created using the clustered approach.

Given at most fₘₐₓ orthogonal frequency channels and tₘₐₓ time intervals that represent a repeating schedule, a super cluster is created consisting of fₘₐₓ times tₘₐₓ clusters. In principle, each cluster within the super cluster is given (through assignment or self-organisation mechanisms) a different combination of frequency channel (denoted with f) and time interval (denoted with t). As a result, each cluster within a super cluster is able to communicate without causing interference to any other cluster in the same super cluster, because communication takes place simultaneously in the different frequency channels, but never simultaneously in the same frequency channel.

Clusters from one super cluster can cause interference with clusters from other super clusters. Super clusters are to be aligned such that the distance between interfering clusters (i.e. same t,f combination) is maximal. Super clusters might contain less than the maximum of fₘₐₓ times tₘₐₓ rectangular clusters, if—for example—a smaller coverage area is required.

Mitigating Co-channel Interference

In practical situations, the number of (orthogonal) frequencies (fₘₐₓ) is limited and the use of large number of time slots (tₘₐₓ) is impractical due to stringent synchronization requirements. The number of frequency channels (fₘₐₓ) is given by transceiver choice and/or standards, (ISM) bands, licensed bands etc. The number of time slots is a design choice with respect to the required raw bandwidth. Given tₘₐₓ, the required sensor data bandwidth, the number of devices per cluster and overhead, one can calculate the raw bandwidth a transceiver must be able to support.

An important measure to determine the success of a large-scale wireless sensor and actuator network using the aforementioned communication strategies is the amount of co-channel interference (CCI) i.e. how much the devices in the network interfere with themselves. A valid feasibility check would therefore be centred on co-channel interference calculations.

A first option would be centred on the tuning of the parameters f and t. Given the required raw bandwidth per cluster and the bandwidth of the selected transceiver, tₘₐₓ can be calculated. Next, fₘₐₓ is determined by calculating the maximum CCI for a given topology and comparing this with the CCI acceptance of the selected RF transceiver.

A second option would be centred on the selection of a feasible RF transceiver. The maximum CCI is calculated given the deployment setup. Next, a transceiver would selected that is able to (1) deliver the above mentioned raw bandwidth, (2) fₘₐₓ channels and (3) is robust against the calculated maximum CCI. Calculations can either assume a finite or infinite deployment.

### DETAILED DESCRIPTION OF FIGURES

FIG. 1 illustrates the components of the large-scale wireless sensor and actuator network:
At macro-scale, wireless sensors are grouped into clusters (11), (12), (13). Clusters can have any arbitrary geographical shapes, such as, but not limited to closed polygons. A set of clusters in which communication does not interfere, because micro-scale communication takes place in different time slots and/or different (orthogonal) frequency channels is called a super cluster. A super cluster is formed from adjacent clusters. A cluster belongs always to exactly one super cluster. Super clusters can be identified by unique identifiers.
Data collector devices (DCs), denoted with (21), (22), (23), control the communication within the cluster (i.e. a group of wireless sensors within a geographical area or a logical group of wireless sensors). There is exactly one data collector device per cluster. Data collectors are able to backlog information until it can be transferred to a central storage point.
Storage point (SP), denoted with (31), (32), (33), which collects sensor information generated by wireless sensors in the large-scale wireless sensor and actuator network. Its physical location may be anywhere (within one cluster or even outside the clusters). Optionally, the functionality of the storage point can be integrated with a data collector (DC). There is at least one storage point per network.
Wireless sensors and/or actuators (41) to (47) belong to exactly one cluster and its aim is to deliver its sampled sensor data to the data collector device within its cluster.

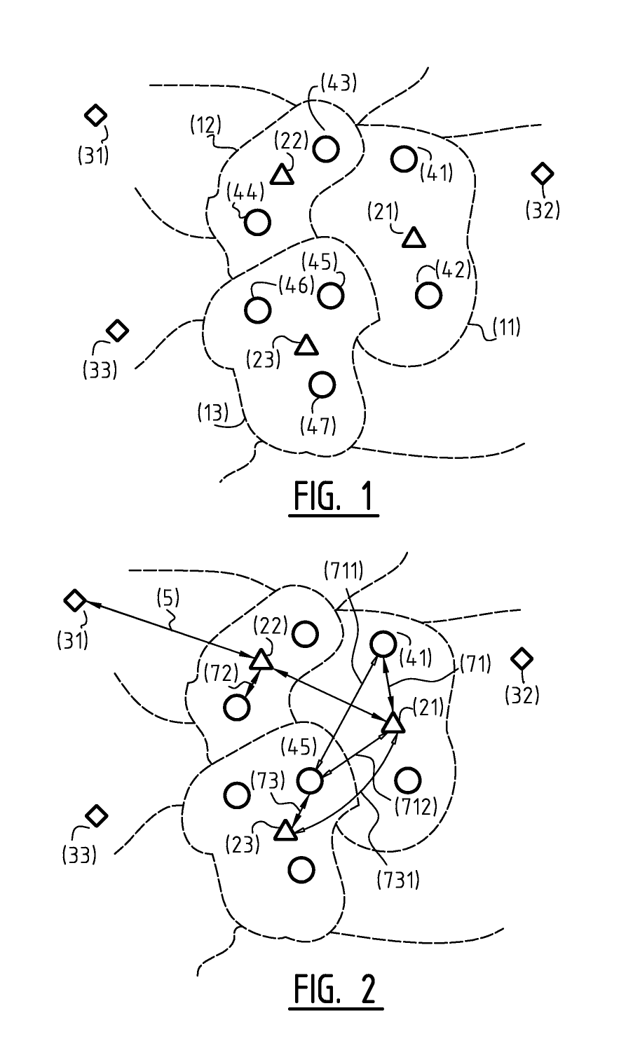

FIG. 2 depicts communication patterns in the large-scale wireless sensor network and potential interference that can occur:
At macro-scale, the DCs communicate with SPs via a separate high bandwidth radio link, wired link or optical link (5). In another embodiment of this invention, a multi-hop link (6) is used i.e. DCs act as relays. The storage points aggregate the information of many clusters and store the information for future reference. The storage point can transfer (but not limited to) configuration—in particular t,f assignments to DCs, if a centralized approach for t,f assignment has been chosen—synchronization and control information to the data collectors (either unicast or multicast). In their turn, data collectors transmit status information and collected sensor information.
The DC contains thus at least two wireless communication modalities. The first is intended to communicate with sensors within the cluster (71), (72), (73), the other to communicate with the storage point or (optionally) with other data collectors. Both communication modalities are able to operate at the same time instance, although this is not strictly necessary. Typically, both transceivers will operate a different carrier frequencies and might have different modulation techniques and bit rates.
At certain points in time, one wireless sensor (41) transmits information to the data collector (21) within its cluster or the DC transmits configuration, actuation commands or other information to one or more sensor nodes. The wireless communication within the cluster is organized such that exactly one device transmits within the cluster per instance of time, indicated with (71), (72), (73). A communication protocol is provided in this document.
Any wireless transmission (71), (72), (73) can cause interference with transmissions in other clusters in the large-scale wireless sensor and actuator network. The interference is denoted with (711), (712), (731). Not all interference possibilities are drawn in FIG. 2. Aim of the organization of communication is to limit the interference to acceptable levels, such that the wireless links between data collector and wireless sensors are not significantly degraded by interference. Data collector devices may actively use transmissions originating from other clusters to (but not limited to) enable self-organization of communication, synchronization or finding its geographical or logical position. Within a super cluster, transmissions do not interfere.

FIG. 3 depicts the communication protocol for wireless sensor to/from data collector wireless communication (i.e. micro-scale communication):

Ad (8): The protocol uses the concept of frames i.e. the structure of the protocol is periodically repeated. The protocol operates in one frequency band, however, multiple instances of the protocol might be active at different and the same frequency band in the same large-scale wireless sensor network. The multiple instances of the protocol are depicted in FIG. 4. To all used packet types, Forward Error Correction (FEC) coding might be applied.

Ad (80): The Poll Message (PM) is transmitted by the data collector device. All wireless sensor devices in the cluster receive this message. The PM messages contain at least, but not limited to, the following:
a. Protocol header (e.g. message type, encryption flags, etc.)
b. Identification number of data collector
c. Identification number of the cluster
d. Accurate timing information (both actual time and protocol timing information). The sensor nodes use this timing as reference.
e. Protocol parameters
   i. Number of data blocks (DMs) before Frame End Message (FEM)
   ii. Duration of the frame
   iii. Maximum size of data blocks
   iv. Maximum output power to be used by the wireless sensors
   v. Frequency channel
f. Allocation of data messages (DM) following the PM. The allocation consists of a list with one entry per DM. Entries can be marked as reserved for a particular device, random access, prohibited from use or broadcast from data collector. Typically, an entry consists of a logical index of a DM and a device address or address mask.
g. Acknowledgement vector for previous data messages
h. (Optionally) Short commands for sensors e.g. actuation commands
i. (Optionally) Position coordinates of the data collector
j. Protocol footer (e.g. CRC, encryption check codes, etc).

Ad (81): The protocol allows a short turn-around time for the sensor node, which is allowed to transmit in the next DM block (this time is required to prepare a DM packet and to change the state of its wireless transceiver). The duration of this time is set depending on the transceiver being used.

Ad (87): The Data Message (DM) carries the information payload. The data collector receives all DMs according to the schedule it indicated in its PM. In order to conserve energy, sensor nodes might not overhear packets from other sensor nodes. However, if the application of the large-scale wireless sensor and actuator networks allows efficient data handling (e.g. compression), sensors might overhear DMs from other sensors to apply locally this efficient data handling. The packet contains at least the following:
a. Protocol header (e.g. message type, encryption flags, etc.)
b. Identification number of sensor node
c. (Optionally) Destination of the packet (used for packets originating from data collector)
d. (Optionally) Position of the device or an estimate
e. (Optionally) Protocol parameters.
f. (Optionally) Received signal strength of the PM
g. Payload, that complies with the request in the PM. The payload may contain pre-processed data e.g. correlation calculations of sensor samples.
h. Protocol footer (e.g. CRC, encryption check codes, etc).

Ad (82): The protocol allows a small interval between DMs to allow the data collector to process received packet (and to prepare a packet to be transmitted, if required), to allow clock drift between the various devices and to guarantee that receivers (that need to receive) are ready before the next DM is transmitted.

Ad (83): A variable number of DMs can be requested in the PM.

Ad (84): After the last DM, the protocol allows a small time interval for the data collector to process the last received DM and to prepare the FEM.

Ad (85): The data collector transmits a Frame End Message (FEM). This message is received by all sensor nodes, which transmitted a DM. It services as acknowledgement to the data or received random access messages. Additionally, it carries received signal strengths of each received DM by the data collector. This allows for autonomous tuning of transmit power (limited by the value in the PM) within the sensor nodes. The received signal strength can be determined by either using successful received packets or by measuring energy levels of received carrier signals.

Ad (86): The protocol implements a silent period. None of the devices in the cluster will transmit during this period. In fact, other clusters might be active during this period in the same frequency band. The data collectors need to make sure that the schedules do not collide. For this purposes, the DCs take assigned t,f combination into consideration. The sensor nodes carefully remain synchronized and wake in time to receive the next PM of the data collector of their cluster. Again, clock drift has to be taken into account for setting a wake-up time in the sensor nodes (i.e. sensor nodes need to switch to receive before the PM is transmitted).

FIG. 4 depicts multiple instances of the protocol that are active at different, and the same frequency band in the same large-scale wireless sensor network. Each of the data collectors execute single instances of the protocol and follow their t,f assignment (either trough self-configuration or central assignment).

Ad (88): Time slots for one particular instance of the protocol, depicted in FIG. 3, repeat every frame.

Ad (89): Within a frame, different instances of the micro-scale protocol might be active. Each of these instances uses identical frame durations, but are time shifted. The individual DCs make sure that they and the sensor/actuator nodes belonging to their cluster, do not communicate after FEM until the next PM.

Ad (890): There might be unoccupied time intervals at macro-scale. These intervals can be reserved to add more clusters to the deployment or to (temporarily) assign more bandwidth to clusters. A (orthogonal) frequency channel is indicated by (891). The micro-scale protocol can simultaneously be applied at various positions in the frequency spectrum.

### EXAMPLE EMBODIMENT OF THE INVENTION

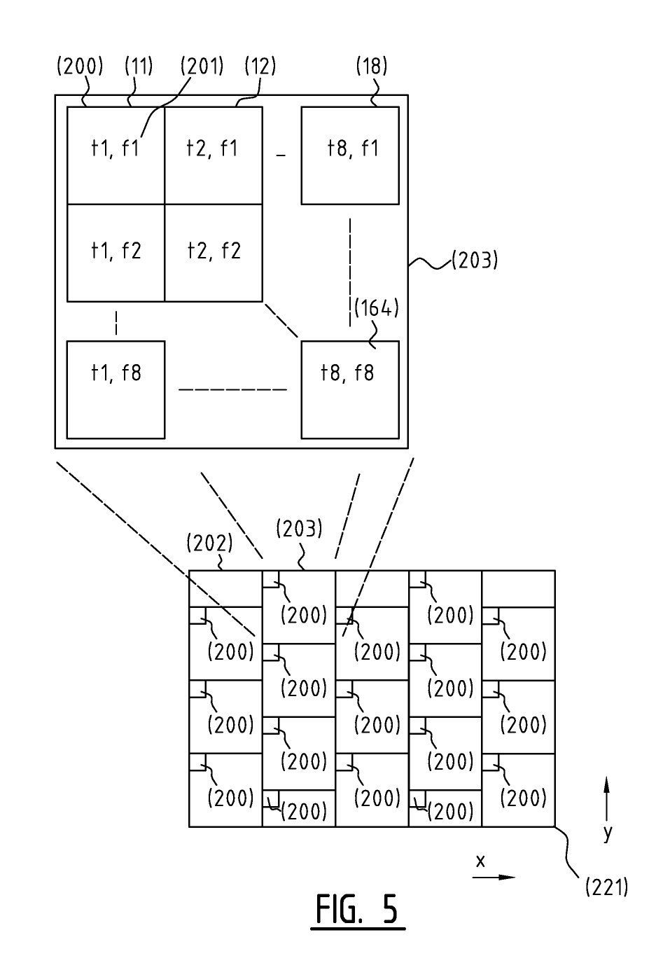

FIG. 5 depicts an example embodiment of the invention. Wireless sensor/actuator nodes are deployed in a rectangular grid with 5 m spacing between nodes in both rows and columns of the deployment (not drawn in FIG. 5). In the example embodiment of the invention, a cluster consists of 100 sensor nodes and covering 2500 m² with a square cluster shape of 50 m times 50 m.

In the example embodiment, the number of (orthogonal) frequencies (fₘₐₓ) is limited to 8 and the number of time slots (tₘₐₓ) is set to 8. Each of the clusters ((11) to (164)) uses a unique combination of frequency channel and time slot out of the 64 combinations. The combination label is indicated by (201). Clusters can communicated without interference within a super cluster (203), however clusters can interfere with clusters from other super clusters. Super clusters are spatially such aligned that interference is minimized. For example, all clusters that use combination t₁, f₁—indicated by (200)—interfere with each other. The feasibility of the example embodiment can be verified by calculating the maximum ratio of all emitted RF power by interfering clusters (200) excluding one target cluster (e.g. (11), which also uses t₁, f₁) and the energy of transmissions in the target cluster, both seen from a target device within the targeted cluster (11). The deployment is feasible for the target device if its transceiver is robust against the calculated co-channel interference ratio. When the deployment is not feasible, the parameters tₘₐₓ and fₘₐₓ can be tuned or a different transceiver technology should be selected. In addition to checking feasibility with respect to co-channel interference, also data throughput must be taken into consideration.

The embodiments shown here are only shown for illustrative purposes and are in not limiting the present invention. It will be apparent to the person skilled in the art that numerous modifications and adaptations are possible within the present invention. For example, the person skilled in the art will understand that features from different embodiments can be combined without departing from the present invention. The scope of protection sought is only limited by the appended claims.

1. Communication method for high density wireless networks, comprising the steps of:
providing a terminal comprising a radio receiver, the terminal being comprised by one cluster comprising at least one terminal, and wherein the cluster is associated with a geographical area wherein the terminal is located; for each cluster,
providing a cluster master device associated with the cluster, the cluster master device comprising a radio transmitter and a radio receiver; and
providing a central node associated with at least one cluster, the central node comprising a radio transmitter and a radio receiver;
wherein a plurality of clusters are associated with a super cluster; wherein communication slots are delimited in time and frequency;
further comprising the steps of:
within a super cluster, allocating unique communication slots to clusters, such that the super cluster and its neighboring super clusters are aligned such that the distance between clusters with identical communication slots is maximal, in order to minimize the co-channel interference;
the cluster master device determining a schedule allocating communication slots allocated to the cluster, to the terminals comprised in the cluster;
the cluster master device communicating the schedule to the terminals comprised in the cluster.

2. Method according to claim 1, wherein the terminal comprises an actuator for executing a command received from the cluster master device.

3. Method according to claim 1, wherein the terminal comprises a sensor for measuring a physical quantity, the terminal further comprising a radio transmitter for communicating a representation of the measured quantity to the cluster master device during a communication slot allocated to the terminal.

4. Method according to claim 1, wherein the terminal further comprises a radio transmitter, the method further comprising the steps of:
the cluster master device determining a quality metric of the signal received from a terminal;
the cluster master device including the determined received signal quality metric in a subsequent transmission; and
the terminal for which the received signal quality metric was determined, adjusting its transmitting power in order to minimize the transmitting power without the received signal quality metric dropping below a predetermined threshold.

5. Method according to claim 1, wherein the terminal further comprises a radio transmitter, the method further comprising the steps of:
a terminal determining a quality metric of the signal received from a cluster master device;
the terminal including the determined quality metric of the received signal in a subsequent transmission; and
the cluster master device for which the received signal quality metric was determined, adjusting its transmitting power in order to the transmitting power without the received signal quality metric dropping below a predetermined threshold.

6. Method according to claim 4, wherein the quality metric is the signal strength or the signal to noise ratio of the received signal.

7. Terminal comprising:
a radio receiver, and an actuator;
wherein the terminal is associated with a cluster comprising at least a terminal and a cluster master device; and
wherein the terminal is configured to:
receive a schedule comprising allocations allocating a communication slot, delimited in time and frequency, to the terminal; and
receive a command to be executed by the actuator during the communication slot allocated to the terminal.

8. Terminal comprising:
a radio receiver, a radio transmitter, and a sensor;
wherein the terminal is associated with a cluster comprising at least a terminal and a cluster master device; and
wherein the terminal is configured to:
receive a schedule comprising allocations allocating a communication slot, delimited in time and frequency, to the terminal; and
transmit measurement data acquired by the sensor during the communication slot allocated to the terminal.

9. Terminal according to claim 8, the terminal further comprising:
quality metric determination means for determining a quality metric for the signal received from a cluster master device, wherein the quality metric determination means are connected to the transmitter; and wherein the terminal is configured to send after determination of the quality metric, during a subsequent transmission, the determined received signal quality metric by means of the transmitter.

10. Terminal according to claim 8, the terminal further comprising:
transmitting power control means connected to the transmitter for controlling the power of the transmitter, the transmitting power control means further being connected to the receiver; wherein the receiver is configured to receive a received signal quality metric; and the transmitting power control means are configured to minimize the transmitting power while keeping the received signal quality metric above a predetermined threshold.

11. Cluster master device comprising:
a radio receiver, and a radio transmitter;
wherein the cluster master device is comprised by a cluster, further comprising at least a terminal; and
wherein the cluster master device is configured to determine a schedule comprising allocations allocating a communication slot, delimited in time and frequency, to each terminal associated with the cluster; and
wherein the cluster master device is configured to:
transmit to a terminal in its associated cluster, the terminal comprising an actuator, a command to be executed by the actuator, the transmission of the command being scheduled during the communication slot allocated to the terminal according to the transmitted schedule; and/or
receive from a terminal in its associated cluster, the terminal comprising a sensor, measurement data acquired by the sensor, the transmission of the measurement data being scheduled during the communication slot allocated to the terminal according to the transmitted schedule.

12. Cluster master device according to claim 11, further configured to transmit to a central node measurement data received from a terminal comprising a sensor, to store the measurement data.

13. Cluster master device according to claim 11, configured to receive from a central node a plurality of allocations of communication slots, the communication slots being delimited in time and frequency, and to determine the schedule comprising the allocations in accordance with the plurality of received allocations.

14. Cluster master device according to claim 11, configured to:
receive a schedule transmitted by a second cluster master device and associated with a second cluster; and
determine the schedule comprising the allocations of communication slots for the cluster associated with it by avoiding the usage of allocations of communication slots comprised in the received schedule of the second cluster master device.

15. Cluster master device according to claim 11, comprising quality metric determination means for determining a quality metric for the signal received from a terminal, wherein the quality metric determination means are connected to the transmitter; and wherein the cluster master device is configured to send after determination of the quality metric, during a subsequent transmission, the determined received signal quality metric by means of the transmitter.

16. Cluster master device according to claim 11, comprising:
transmitting power control means connected to the transmitter for controlling the power of the transmitter, the transmitting power control means further being connected to the receiver;
wherein the receiver is configured to receive a received signal quality metric; and
the transmitting power control means are configured to minimize the transmitting power while keeping the received signal quality metric above a predetermined threshold.

17. Apparatus according to claim 7, wherein the received signal quality metric is the signal strength or the signal to noise ratio of the received signal.

18. Central node comprising:
a radio receiver, and a data storage;
wherein the central node is configured to receive measurement data from a cluster master device, and to store the received measurement data in the data storage.

19. Central node comprising:
a radio transmitter for communicating with at least one cluster master device, the cluster master device being comprised in a cluster further comprising at least one terminal, the cluster being comprised in a super cluster comprising at least one further cluster;
means for determining for each cluster in the super cluster, an allocation of communication slots, delimited in time and frequency, such that the super cluster and its neighboring super clusters are aligned such that the distance between clusters with identical communication slots is maximal, in order to minimize the co-channel interference;
wherein the central node is configured to transmit the allocation of communication slots to the cluster master device of each cluster in the super cluster.

20. System comprising a terminal comprising:
a radio receiver, and an actuator;
wherein the terminal is associated with a cluster comprising at least a terminal and a cluster master device; and
wherein the terminal is configured to:
receive a schedule comprising allocations allocating a communication slot, delimited in time and frequency, to the terminal; and
receive a command to be executed by the actuator during the communication slot allocated to the terminal;
a cluster master device comprising a radio receiver, and a radio transmitter;
wherein the cluster master device is comprised by a cluster, further comprising at least a terminal; and
wherein the cluster master device is configured to determine a schedule comprising allocations allocating a communication slot, delimited in time and frequency, to each terminal associated with the cluster; and
wherein the cluster master device is configured to:
transmit to a terminal in its associated cluster, the terminal comprising an actuator, a command to be executed by the actuator, the transmission of the command being scheduled during the communication slot allocated to the terminal according to the transmitted schedule; and/or
receive from a terminal in its associated cluster, the terminal comprising a sensor, measurement data acquired by the sensor, the transmission of the measurement data being scheduled during the communication slot allocated to the terminal according to the transmitted schedule; and
a central node comprising:
a radio receiver, and a data storage;
wherein the central node is configured to receive measurement data from a cluster master device, and to store the received measurement data in the data storage.
